(19) United States
(12) Patent Application Publication
(10) Pub. No.: US 2026/0202025 A1
(43) Pub. Date: Jul. 16, 2026

(54) Solar Light Assembly

(71) Applicant: CLEAR BLUE TECHNOLOGIES INC., Toronto (CA)

(72) Inventors: John TUERK, Toronto (CA); Piotr MIKUS, Toronto (CA)

(21) Appl. No.: 19/136,336

(22) PCT Filed: Dec. 12, 2023
(86) PCT No.: PCT/CA2023/000033

§ 371 Date: Jun. 6, 2025

Related U.S. Application Data
(60) Provisional application No. 63/433,774, filed on Dec. 20, 2022.

(51) Int. Cl. F21S 9/03; F21V 15/01; F21V 21/116; F21V 21/15; F21V 21/30; F21W 131/103; F21W 131/107; F21Y 105/10; F21Y 115/10; H02J 7/02; H02J 7/35; H05B 47/19

(52) U.S. Cl. CPC F21S 9/037; F21V 15/01; F21V 21/116; F21V 21/15; F21V 21/30; H02J 7/02; H02J 7/35; H05B 47/19; F21W 2131/103; F21W 2131/107; F21Y 2105/10; F21Y 2115/10

(57) ABSTRACT

A solar light assembly includes a housing, a photovoltaic panel, an electric lamp, an electric battery cell and a controller electronically connecting the battery cell with the photovoltaic panel and electric lamp. The housing includes a lower pan and a cover. The lower pan for fixed mounting relative to a support and with the lamp being fixedly mounted to said base. The photovoltaic panel is mounted to a top surface of the cover which is inclined at an angle at between about 10° and 33°, and which is configured for selective rotary movement about a generally vertical axis relative to the lower pan.

### RELATED APPLICATIONS

This application claims priority to and the benefit of 35 USC § 119(e) to U.S. Patent Application Ser. No. 63/433774, filed Dec. 20, 2022, the entirety of which is incorporated herein by reference.

### SCOPE OF THE INVENTION

The present invention relates to a solar light assembly which incorporates a photovoltaic panel, an electric lamp and one or more electric battery cells, and more particularly to a solar light assembly in which the photovoltaic panel is mounted to part of a light assembly housing which is configured for selective rotational positioning relative to a mounting support, whilst the lamp is maintained in a fixed orientation. More preferably, the solar light assembly is provided as a self-contained or all-in-one solar light assembly, or is otherwise provided for retrofit application as a replacement for conventional incandescent mercury vapour or halogen lighting.

### BACKGROUND OF THE INVENTION

All-in-one or self-contained solar streetlamps and light fixtures are known for use in providing downlight illumination to roadways, sidewalks, parking lots, foot paths, structures and other target areas. As shown in FIG. 1, convention all-in-one fixtures 10 typically include a rectangular solar or photovoltaic panel 12 and an LED electric lamp or luminaire 16 configured for positioning above the target area T_{A} to be lit. In conventional street light applications, the solar panel is positioned on top of a lamp pole 14 upwardly inclined at a 20° to 30° angle, with the LED electric lamp or luminaire 16 is secured to the underside of the panel 12 to orient emitted light generally downward towards the target area T_{A}.

The mounting of the LED lamp to the underside of the photovoltaic panel adversely limits the ability to reposition the photovoltaic panel to optimize its solar efficiency. In particular, because it is necessary to mount the fixture 10 with the LED lamp oriented towards, and typically above the target area T_{A}, it is not possible to separately position the photovoltaic panel to optimize solar energy input, as for example having regard to the street lamp geography and/or the existence of surrounding or covering structures.

Because the photovoltaic panel 12 is positioned on the pole 14 in an upwardly inclined angle for charging efficiencies, the mounting of the LED lamp 16 to the underside of the panel 12 typically results in the tilted positioning of the light fixture or LED lamp. As a result, the principal focus of so light emitted by the light fixture is typically directed in an orientation inclined well above 10°, and frequently more than 20° relative to the nadir angle of fixture. This tilted positioning often results in increased light spillage, whereby light emitted by the LED lamp 16 falls outside the intended target area T_{A} to be illuminated. Light spillage, or light trespass, is particularly problematic in the case of LED lamps 16 which incorporate white LEDs operable to emit high intensity white light. Light spillage of high intensity white light may produce undesirable veiling luminance on neighboring properties and/or individuals, particularly in the case where the light fixture 10 is mounted on taller lamp poles 14 greater than 4 meters above the target area T_{A}.

In addition, the rectangular configuration of the photovoltaic panel 12 provides the fixture 10 with a broad horizontal top edge or roosting surface 18. As a result, birds will tend to nest or roost along the top surface 18 with a result that bird guano and nesting debris may tend to ultimately accumulate on and occlude the photovoltaic panel 12, impacting its operational efficiency.

### SUMMARY OF THE INVENTION

Accordingly, one construction of the present invention provides a solar light assembly which is operable to illuminate a target area, and which is mountable on a light pole, building facia, eves and/or in higher environments, whilst reducing or minimizing Backlight Uplight Glare (BUG) or light spillage. In one non-limiting construction, the solar light assembly is provided as a replacement assembly, and in preferred constructions as a self-contained, all-in-one replacement assembly for retrofitting conventional incandescent, mercury vapour and/or halogen street lighting. In other non-limiting constructions, the solar lighting assembly may be provided for new residential, commercial or municipal use as exterior building, roadway or sidewalk/pathway lighting.

More preferably, aspects of the invention provide a solar powered light fixture having a lamp assembly and photovoltaic panel which allows for repositioning of the light assembly photovoltaic panel, whilst maintaining the light assembly lamp in a fixed and/or preselected orientation chosen to minimize the spillage of emitted light and/or undesirable glare effects outside a target area.

Another embodiment of the invention provides an all-in-one solar light assembly which incorporates a solar or photovoltaic panel, one or more electric battery cells, and an electric lamp assembly as a single unit, and which allows for both simplified mounting to an assembly support such as a light pole, building structure, mounting area or bracket or other suitable mount surface, and which once mounted allows for a site-specific, more optimized positioning of the photovoltaic panel for increased operational and/or solar charging efficiencies.

A further aspect of the invention provides an all-in-one solar light assembly which has a housing construction configured to minimize horizontal top or edge surfaces which could function as a bird roosting surface or perch. Whilst not essential, in a more preferred construction the all-in-one solar light assembly is provided with a self-contained internal power source, such as lithium ion or lithium iron batteries, or other rechargeable fuel cells for providing electrical power to the electric lamp assembly, housed within the housing construction, external batteries and/or other power sources may also be provided depending on security and maintenance requirements.

A further aspect of the invention is to provide an all-in-one or self-contained solar light assembly which incorporates a substantially weather-tight assembly housing having both fixed and selectively movable parts, and where a photovoltaic panel is integrated into or mounted to a movable top or cover part of the assembly housing so as to be selectively repositionable relative to a mounting support.

In another non-limiting embodiment, a solar light assembly is provided for illuminating a selected target area. The solar light assembly includes an assembly housing, a photovoltaic panel which is operable to generate electric current, an electric lamp assembly and one or more electric battery cells in electric communication with the photovoltaic panel and the electric lamp assembly. The assembly housing preferably includes the housing top or cover and a base or bottom portion. The top or cover is used to mount the photovoltaics panel, and is selectively moveable to allow for the photovoltaic panel to be repositioned or reoriented for increased solar efficiency. More preferably, the photovoltaic panel is coupled or secured to the housing top or cover so as to be repositionable about a rotation axis which extends in a substantially vertical ±20° orientation; whilst the electric lamp is maintained oriented in a substantially preset or static position.

In another non-limiting embodiment, the solar light assembly is provided for retrofit applications as a more energy efficient replacement for conventional 120 volt/ 220 volt municipal street and/or exterior building lighting. Although not essential, the solar light assembly electric battery cells may be selectively provided in electrical communication with an external power charging source, such as municipal AC power, as for example by way of a charge controller and/or battery management unit (BMU). In a preferred mode, the charge controller/BMU is configured to effect charging and/or battery maintenance with power supplied from the external power charging source if current generated by the photovoltaic panel falls below a threshold amount for a preselected time.

In other non-limiting embodiments, the solar light assembly includes a light assembly housing having a base or lower portion which is adapted for securement relative to a pole, mounting bracket, building wall or other structure. The housing top or cover portion is preferably provided for mated engagement over or with the housing base or lower portion to define a hollow interior which is largely closed to the environment as a protective enclosure. One or more rechargeable batteries or battery cells, are positioned in the hollow interior for storing and supplying electric power. The battery cells are chargeable by the photovoltaic panel, and are provided as a rechargeable electric power source for the electric lamp assembly.

In a further non-limiting embodiment, the battery cells may include lithium ion or lithium iron fuel cells. Other types of rechargeable fuel cells may also be provided.

Preferably, the photovoltaic panel is coupled to the assembly housing cover portion, and the electric lamp assembly is secured or coupled to the assembly housing base. The housing base is adapted for mounting to a suitable support with the electric lamp assembly operable to direct light emitted therefrom onto a target area to be illuminated. More preferably, the housing base is adapted for fixed coupling on a suitable support in an operating position, whereby the electric lamp assembly is positioned to direct emitted light substantially downwardly onto the selected target area with lessened or reduced light spillage. In one non-limiting construction, the support is most preferably provided as a vertically extending lamp pole adapted for mounting the solar light assembly in an operating position 3 or more meters above the target area. It is envisioned however, that the solar light assembly may be used and mounted on various different environments and supports, including directly to the sides of buildings, as well as on other structures through the use of suitable brackets, arms, ground spikes or other mounting connectors, depending on the target area type and location.

In a most preferred non-limiting embodiment, the assembly housing may be provided as a two-part construction, and includes a moulded plastic or metal base and upper cover or turret portions. The base may be provided as a universal member adapted for use with different sized turrets or covers used to mount one or more photovoltaic panels. In particular, different sized turret diameters may be interchangeably used with a common universal base, depending on the overall size and/or number of the solar panels to be mounted and wattage desired. In this manner, larger solar panels may be supplied where higher wattage may be needed, as for example in geographic latitudes greater than ±45° Preferably, the cover portion is configured for mated placement or positioning over the base to define a hollow housing interior. The hollow interior is most preferably shielded from the environment, and more preferably is sized to house one or more of the rechargeable electric battery cells as a generally sealed enclosure. Preferably, the battery cells are lithium ion cells, and the solar light assembly further includes a battery management unit (BMU) or other suitable processor/controller used to regulate battery cell charging by the photovoltaic panel, and electrical discharge therefrom to power the electric lamp assembly in operation of the solar light assembly. Other types of batteries and/or fuel cells may however also be used, including without restriction nickel cadmium batteries, sodium ion cells, lithium iron phosphate cells and the like. Most preferably, the battery management unit (BMU) or other suitable processor or controller are provided in the housing interior, and further include electric communications hardware allowing for the wireless transmission and/or receipt of control signals used to regulate BMU and/or processor/controlling operations.

The electric lamp assembly is most preferably coupled to the base or lower portion, and preferably to the underside of the bottom of the assembly housing. Most preferably, the electric lamp assembly is fixed to the bottom of the assembly base such that when the light assembly is secured in the operating position, the electric lamp assembly is positioned to emit light generally vertically downwardly onto the target area. Preferably in the operating positions the electric lamp assembly emits light with a generally center beam light focus oriented at a vertical nadir ±25° to the target area, preferably at a vertical nadir ±20°, and most preferably at a vertical nadir ±10°. It is appreciated that in such an orientation the electric light assembly advantageously may operate to direct emitted light onto the target area to be illuminated with lessened spillage and/or neighboring glare.

In another non-limiting embodiment, the electric lamp assembly incorporates an LED module or panel, and more preferably a white LED panel. Other types of LEDs may however be used. The LED module may be provided as a modular insert which is interchangeable having regard to the site specific Target Area T_{A} to be illuminated. The LED panel is generally planar and is mounted to the lower side of the housing. Preferably, the LED panel is positioned recessed into the underside of the housing base, so that when the solar light assembly is secured in the operating position on the support, the LED panel is positioned in a generally horizontal ±10°, preferably horizontal ±5° position. Most preferably, the LED panel includes white LEDs which direct light emitted therefrom downwards towards the target area, and most preferably substantially at a zero ±10° angle nadir. More preferably the lower side of the housing is mounted in the operating position such that the beam angle of the emitted light at the target area surface is optimized to the overall efficiency of the LED panel or module. Preferably, optimization is achieved at the target area in accordance with IES-RP-8-18; IES-RP-8-21; and/or IES-RP-33-14 standards.

In one preferred construction the assembly housing upper cover is preferably formed having a substantially planar top surface other surface configurations may however be used. The top surface preferably directly supports the mounting of the photovoltaic panel thereon. The top surface is preferably oriented so that when the solar light assembly is mounted in its operating position, the photovoltaic panel is inclined relative to the horizontal, and preferably is inclined at an angle of between about 10° and 33° from horizontal, preferably between about 10° and 20°, and most preferably at about 15° to increase panel solar efficiency. Different mounting orientations may however, be selected depending on the final installation site selection.

Preferably, the upper cover includes a radially extending sidewall which extends beneath the upper surface, and which extends inwardly towards an annular inner wall. In a non-limiting construction, the annular inner wall is configured to at least partially overlie or matedly engage an uppermost radially extending portion of the housing base.

The upper cover is adapted to allow for the selective rotation of the top surface and the photovoltaic panel about a generally vertical axis and relative to the lower base. In a most preferred embodiment, the upper cover portion is provided as a rotatable turret which is repositionable relative to the housing base, while the base remains fixed in a preselected or optimized position.

In another non-limiting embodiment, the upper cover portion is adapted for manual positioning relative to the base towards an orientation to optimize the charging efficiency of the photovoltaic panel at the time of initial solar light assembly installation and placement on the support. Thereafter, the upper cover portion may be secured in its fixed optimized orientation, as for example by the placement of removable mechanical fasteners such as screws, clips, pins, or the like. In an alternative construction, the solar light assembly may be provided with an electric drive motor selectively activatable to effect rotation and repositioning of the upper cover portion and photovoltaic panel relative to the house base.

In another non-limiting embodiment, the controller may be used to activate the drive motor on a preselected timed basis, as for example daily and/or seasonally, to reorient the photovoltaic panel to one or more preselected positions chosen to maximize solar efficiencies. In an alternate embodiment, the solar light assembly may incorporate one or more light sensors. The light sensors are preferably provided in electronic communication with the controller to automatically send signals and effect motor activation to reposition the top cover and photovoltaic panel in accordance with detected input light intensity in real time.

It is to be appreciated that the selective rotation of the upper cover portion as a moveable turret, allows for the independent adjustment of the direction and/or angle of the photovoltaic panel to positions to maximize solar panel efficiencies, whilst maintaining the electric lamp or LED module in its initial fixed pre-selected or optimized orientation.

The present invention may reside in various non-limiting aspects, and which for example may include without restriction:
1. A solar light assembly for mounting in an operating position to effect illumination of a target area, the solar light assembly comprising an assembly housing, a photovoltaic panel, an electric lamp, an electric battery cell and a controller, the controller being operable to selectively electronically connect said battery cell with said photovoltaic panel and said electric lamp, said housing comprising a lower pan portion and an upper cover portion, the lower pan portion including a base adapted for fixed securement to effect mounting of the solar light assembly in the operating position, relative to an assembly support, with the base in a generally horizontal orientation, the lamp being fixedly mounted to said base, the upper cover portion including an upper surface when the solar light assembly is mounted in the operating position, the upper surface being inclined relative to the horizontal an angle selected at between about 10° and 45°, preferably between about 10° and 33°, and most preferably at about 15° to about 20°, and with the upper portion being configured for selective rotational movement about a generally vertical axis relative to said lower pan portion, the photovoltaic panel being mounted to said upper cover portion in a fixed orientation relative to said inclined upper surface for movement therewith.

2. A solar light assembly adapted for positioning in a fixedly mounted orientation on a support, the assembly comprising a lamp housing, a photovoltaic panel, a luminaire and an electric power control assembly including at least one electric cell in electrical connection with the photovoltaic panel and the luminaire, and optionally a controller, the lamp housing including a lower pan portion and an upper cover portion, wherein in the fixedly mounted orientation, the lower pan portion having a generally horizontally extending base and an upwardly extending sidewall extending radially about an edge portion of said base to an upper edge, and the upper cover portion positionable over the lower pan portion to define an interior cavity therebetween, the upper cover portion having a generally planar top surface or panel and a lower s portion beneath the cover portion, the top panel being oriented to an inclined angle relative to horizontal at an angle selected at between about 10° and 45°, preferably between about 10° and 33° and most preferably about 15° and 20°, the lower portion optionally including a downwardly extending sidewall extending radially and concentric with at least part of said upwardly extending sidewall for juxtaposed and/or concentric placement therewith, wherein upper cover portion is configured for selective rotary positioning relative to said lower pan portion, the photovoltaic panel being mounted to the top surface or panel in a generally parallel planer relationship therewith, the luminaire being mounted to said base, and the at least one electric cell and a controller housed within said interior cavity, the controller operable to control charging of said electric cell by said photovoltaic panel and the discharge of electricity therefrom in operation of the luminaire.
3. A solar light assembly for mounting to a support in a mounted orientation substantially above a target area to be illuminated, the solar light assembly including, an assembly housing comprising a lower housing portion, an upper cover portion, an electric battery cell and a controller for controlling battery cell charging and/or discharge, the lower housing portion adapted for fixed coupling to the support, the lower portion including, a base, a base sidewall including a radially and upwardly extending portion, and an electric lamp secured to said base, whereby in the mounted position the electric lamp is oriented to emit light energy toward said target area, the upper cover portion comprising: an upper surface, and preferably a generally circular upper surface, extending to an outermost radially extending edge, and a substantially planar photovoltaic panel coupled to the upper surface, a cover sidewall extending downwardly from said outermost radially extending edge, towards said lower housing portion, a lower portion of the cover sidewall defining an inner annual sidewall adapted for juxtaposed placement with the radially and upwardly extending portion of the base sidewall, whereby in the mounted position the upper surface and photovoltaic panel being inclined from horizontal at an angle of between about 10° and 33°, preferably at about 11°, 12°, 13°, 14°, 15°, 16° or 17°, and/or the upper cover portion being selectively rotatable relative to said lower housing portion and preferably being rotatable about a generally vertical axis ±150, between about 90° to at least 270°, preferably at least 360° and most preferably at least 540° of movement.

The assembly of any of the foregoing or hereafter described aspects including the drive assembly including a drive motor selectively activatable to journal the upper portion in rotational movement relative to the lower pan portion, and/or the controller is operable to effect the selective activation and deactivation of the drive motor in response to at least one control factor selected from one or more of the group consisting of a time of day, a current localized weather event, a time of year and a sensed local variable.

The assembly of any of the foregoing or hereafter described aspects, wherein the lower or bottom pan portion includes a radially extending sidewall extending upwardly from the base concentrically about the vertical axis, and/or the upper cover portion includes a radial lower portion adapted for juxtapositioning with at least part of said lower pan sidewall. Although not essential more preferably the upper cover portion includes a truncated cylindrical top portion, and/or the upper cover portion may include a generally planar top surface.

The assembly of any of the foregoing or hereafter described aspects, wherein the upper cover portion and the lower pan portion define a substantially weather-tight interior cavity. Optionally, in another preferred aspect, the controller and the electric battery cell are housed within the interior cavity.

The assembly of any of the foregoing or hereafter described aspects, wherein said upper surface comprises a substantially planar surface, and/or said photovoltaic panel comprises a substantially planar front surface, the photovoltaic panel being mounted on or to said upper cover portion with said planar front surface in a substantially coplanar orientation with said inclined upper surface.

The assembly of any of the foregoing or hereafter described aspects, wherein said photovoltaic panel is recessed at least partially in said inclined upper surface.

The assembly of any of the foregoing or hereafter described aspects, wherein the lower or bottom pan portion further includes a mounting assembly for securing the solar light assembly to said assembly support in a fixedly mounted orientation.

The assembly of any of the foregoing or hereafter described aspects, wherein the assembly support is selected from the group consisting of a light pole, a wall bracket and a support arm.

The assembly of any of the foregoing or hereafter described aspects, wherein said electric lamp comprises an LED array secured to or recessed at least partially into an underside of said base.

The assembly of any of the foregoing or hereafter described aspects, wherein the electric power control assembly further includes a wireless communications transmitter and receiver adapted to transmit and/or receive control programming to control battery cell charging and/or discharge and/or electric lamp operation time or intensity.

The assembly of any of the foregoing or hereafter described aspects, wherein said luminaire is recessed at least partially into an underside of the said base in a preset orientation whereby when the solar light assembly is in operating position, the electric lamp operates to emit light with a center beam light focus oriented at vertical nadir ±25° to the target area.

The assembly of any of the foregoing or hereafter described aspects, wherein the photovoltaic panel is mounted on or recessed into the top panel so as to be substantially coplanar therewith.

The assembly of any of the foregoing or hereafter described aspects, wherein the lamp housing further includes a rotary stop to limit the rotation of the upper cover portion relative to said lower pan portion to between about 180° to at least 359° of movement, and preferably between about 210° and at least 540° of movement.

The assembly of any of the foregoing or hereafter described aspects, further including a removable securement member selectively positionable to secure said upper cover member against rotational movement relative to said base or lower pan member.

The assembly of any of the foregoing or hereafter described aspects, wherein the upper surface merges with the cover sidewall to form a substantially rounded edge having a radial curvature selected to deter bird roosting.

The assembly of any of the foregoing or hereafter described aspects, wherein the photovoltaic panel is substantially flush mounted with or on said upper surface.

The assembly of any of the foregoing or hereafter described aspects, further including a secondary AC power source, and wherein the controller is configured to selectively provide AC-sourced electrical charging power to said battery cell.

The assembly of any of the foregoing or hereafter described aspects, wherein said electric lamp comprises an LED array secured to or recessed at least partially into an underside of said base.

The assembly of any of the foregoing or hereafter described aspects, further including a wireless communications transmitter and receiver communicating with said controller and adapted to transmit and/or receive solar light assembly control programming.

The assembly of any of the foregoing or hereafter described aspects, further including a removable securement member selectively positionable to secure said upper cover member against rotational movement relative to said base.

### BRIEF DESCRIPTION OF THE DRAWINGS

Reference may now be had to the following detailed description, taken together with the accompanying drawings in which:

FIG. 1 shows schematically a prior art all-in-one light fixture used in the illumination of a roadway target area;

FIG. 2 illustrates a light pole which incorporates an all-in-one self-contained solar light assembly in accordance with a preferred embodiment of the invention;

FIG. 3 illustrates a top perspective view of the solar light assembly used in the light assembly of FIG. 2;

FIG. 4 illustrates a bottom perspective view of the solar light assembly shown in FIG. 3;

FIG. 5 illustrates an enlarged cross sectional view of the solar light assembly shown in FIG. 4 taken along 5-5′;

FIG. 6 illustrates a partial enlarged view of the light pole shown in FIG. 1 illustrating schematically the relative movement of the light assembly cover portion, relative to the housing lower pan and lamp pole;

FIG. 7 illustrates schematically, the photovoltaic (PV) cell array used in photovoltaic panel of the solar light assembly shown in FIG. 2;

FIG. 8 illustrates schematically a cross sectional view of the solar light assembly in accordance with a second embodiment of the invention; and

FIG. 9 illustrates schematically a cross sectional view of a light pole which incorporates a solar light assembly in accordance with a third embodiment of the invention.

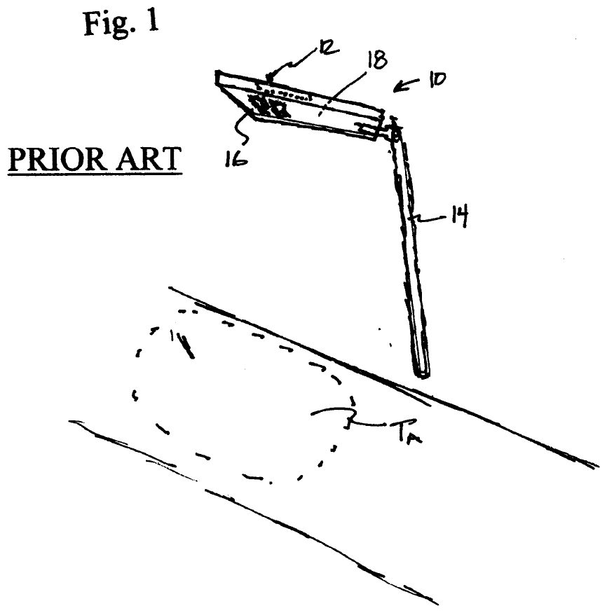

### DETAILED DESCRIPTION OF THE PREFERRED EMBODIMENTS

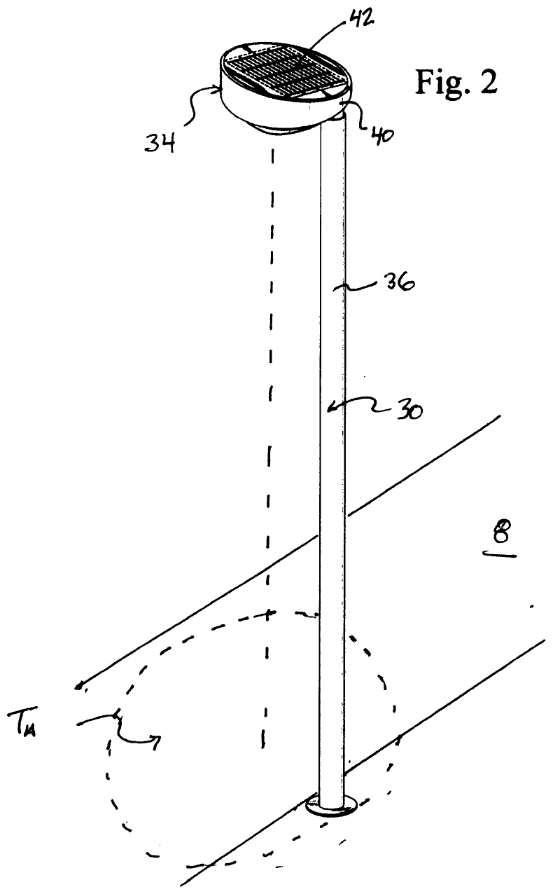

Reference may be had to FIG. 2 which illustrates an autonomously powered street light 30 which is used to illuminate a target area T_{A} of an adjacent roadway 8 in accordance with a preferred embodiment of the invention. The street light 30 includes a self-contained, all-in-one solar light assembly 34 which is shown mounted in an operating position on top of a vertical light pole 36 in a position 3 meters or more above the target area T_{A}.

In a conventional design, the light pole 36 is provided as an extruded aluminum or galvanized metal cylindrical pole having a length selected at between about 3 and 15 meters. Longer or shorter light poles 36 may also be used depending on the target area to be illuminated. It is to be further appreciated that in other configurations, the solar light assembly 34 could be mounted to a variety of different types of supports, including without restriction to horizontal arms or brackets mounted to the side of a building, bridges or other structures.

As will be described, in the operating position, the solar light assembly 34 is operable to emit light downwardly towards the target area T_{A}. Preferably, in the operating position the light assembly operates to emit light with an emitted beam angle focus at the Target Area T_{A}, and preferably illuminates the target area T_{A} in accordance with IES-RP-8-18; IES-RP-8-21; and/or IES-RP-33-14 standards. The solar light assembly 34 preferably is operable to emit light at substantially zero ±10°, and most preferably ±5° angle nadir, so as to reduce BUG and illumination and light trespass outside the target area T_{A}.

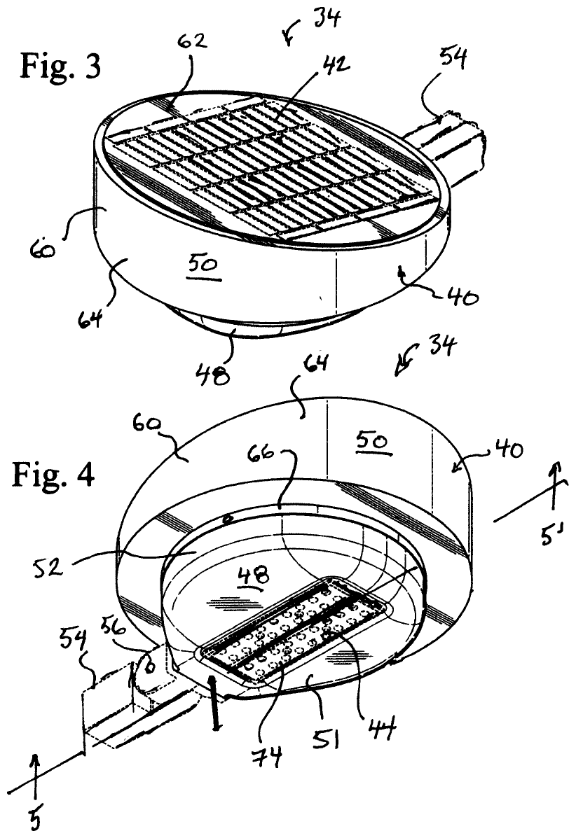

The solar light assembly 34 is shown best in FIGS. 3 to 5 as an all-in-one autonomously powered solar light assembly which includes a housing 40, photovoltaic panel 42, LED light module 44 and internal battery 46. The assembly housing 40, as will be described, is used to mount and allow the positioning of the photovoltaic panel 42 relative LED light module 44. The internal battery 46 preferably includes a series of lithium ion battery cells 48A,48B which are adapted to receive and store electrical power produced by the photovoltaic panel 42, and provide output electrical power to the LED light module 44.

FIGS. 3 and 4 illustrate the assembly housing 40 as being of a two-part construction and including a lower bottom pan 48 and an upper cover 50. The bottom pan 48 and cover 50 are most preferably formed from molded aluminum. In a more economical construction, plastics or other materials may also be used. As will be described, the upper cover 50 is adapted for the selective, turret-type rotational movement relative to the bottom pan 48, to better optimize the operational and solar efficiency of the photovoltaic panel 42, whilst maintaining the LED light module 44 in a substantially preselected orientation. Preferably, the bottom pan 48 the upper cover 50 and the photovoltaic panel 42 are provided in a substantially all black exterior finish. The applicant has appreciated that forming the assembly housing 40 with a substantially entire black finish advantageously may facilitate thermal irradiation and housing warming to facilitate snow and ice melting, which could otherwise occlude the photovoltaic panel 42 in winter months.

Exemplary LED modules 44 are selected depending on the site specific requirements and desired illumination configuration of the target area T_{A}. The bottom pan 48 includes a generally flat base 51 which, when the solar light assembly 34 is mounted to the pole 36 in the operating position illustrated in FIG. 2, extends substantially horizontally, and preferably in a direction generally above the target area T_{A}. A pan sidewall 52 extends radially and upwardly about a periphery of the base 51 to an uppermost annular rim. In a preferred construction, a mounting arm 54 which includes a locking adjustment pivot knuckle 56 is secured to a peripheral side of the pan sidewall 52. The mounting arm 54 is configured for mechanical attachment to a mated bracket formed on the end to the pole 36, and permits mounting of the solar light assembly 34 to the pole 36 in the operating position whilst allowing final adjustment in the orientation of the bottom pan base 51 and LED module 44.

The upper cover 50 is illustrated as having a truncated cylindrical top portion 60 having an integrally formed generally planar top surface 62 and a radial cover sidewall 64 which extends downwardly therefrom. Along its lower edge, the cover sidewall 64 extends inwardly to an open inner annular sidewall 66. Most preferably, at the lower edge of the outer sidewall 64, the cover extends inwardly to the inner sidewall 66, and which extends radially about the pan sidewall 52 in a substantially weather tight arrangement. Most preferably, the uppermost annular rim of the pan sidewall 52 and the inner sidewall 66 of the cover sidewall 64 are formed as complimentary sized rings which are configured for concentric mated juxtapositioning. Most preferably, the inner sidewall 66 is formed with a larger diameter than the juxtaposed portion pan sidewall 52, allowing the upper cover 50 to be mounted over the bottom pan 48. Optionally, a rotary seal 70 extends radially between the pan sidewall 52 and inner sidewall 66.

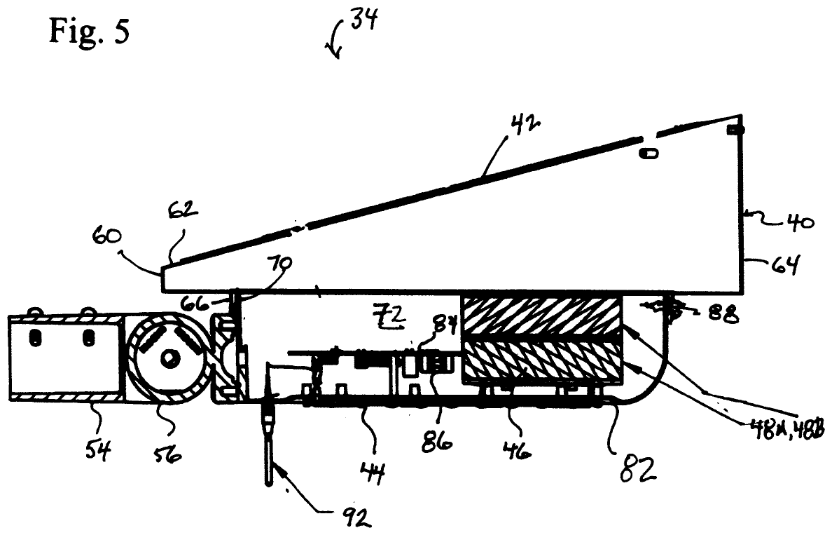

As shown best in FIG. 5, the upper cover 50 is configured for positioning over the lower pan 48 in an assembled orientation with the inner sidewall 66 a substantially juxtaposed orientation overlying the uppermost annular portion of the pan sidewall 52 to define a substantially weather-tight hollow housing interior 72. Further, in the assembled orientation, the top surface 62 is inclined relative to the base 51, such that when the solar light assembly 34 is mounted in the operating position, the top surface 62 is inclined at an angle of 10° to 45°, and most preferably at about 15° to 30° relative to the horizontal.

FIGS. 3 and 5 show best the photovoltaic panel 42 as having a generally planar construction. As will be described, the photovoltaic panel 42 preferably is formed with a series of linear orientation arrays 120a-120f photovoltaic (PV) cells 122 connected in series. The photovoltaic panel 42 is oriented on the top surface 62 relative to the maximum angle of orientation, such that the direction of elongation of each linear array 120 is in a landscape orientation and normal to the maximum inclination axis A_{I}-A_{I} of the top surface 62. In a simplified configuration, the photovoltaic panel 42 is flush mounted on or recessed into and coplanar with the top surface 62 of the upper cover 50. Alternatively, the photovoltaic panel 42 may be mounted in an orientation slightly raised above the top surface 62. Preferably, the photovoltaic panel 42/top surface 62 mounting is effected so as to avoid interference surfaces which could hinder or collect the shedding of water, ice or other debris from moving from the photovoltaic panel surface 42.

The applicant has appreciated that the mounting of the photovoltaic panel 42 above or flush into the top surface 62 advantageously shields internal wiring connections from environmental exposure and possible animal damage. In addition, the raised or flush mounting of the photovoltaic panel 42 in the inclined orientation facilitates its natural rain cleaning; the shedding of snow, dust and debris from the top of the solar light assembly 34, and minimizes or eliminates perching and nesting structures. In particular in the operating position, the inclination and edge profile of the top surface 62 presents a rounded or arcuate extending uppermost edge 63 which merges with the over sidewall 64 and provides a deterrent for bird roosting, which otherwise could result in guano fouling the photovoltaic panel 42.

FIGS. 4 and 5 illustrate the LED module 44 as including an array of multiple white light emitting diodes (LEDs) integrated into a unitary planar panel unit 74. In a simplified construction, the LED panel unit 74 is secured within a complimentary sized recess 82 formed in the bottom pan 48 so as to be substantially coplanar with the base 51. It is to be appreciated that such a configuration advantageously allows for the final adjustment and orientation of down light emitted by the solar light assembly 34 by adjusting any final positioning and orientation of the base 51 by means of the pivot knuckle 56. In an alternative construction, the LED module 44 may be fixed or mounted in a preselected inclined orientation relative to the base 51.

FIG. 5 illustrates best the positioning of the lithium ion battery cells 48A,48B within the housing interior 72. The positioning of the battery cells 48A,48B within the substantially sealed interior 72 allows for their thermal heating by electricity generated by the photovoltaic panel 42, to allow for both snow melting and optimized battery operation in colder environments. In particular, the mounting of the photovoltaic panel 42 on or into and in juxtaposition with the top surface 62 allows for generated heat to directly warm the housing interior 72 above minimum rated battery charging temperatures, depending on the battery cell chemistry.

Most preferably, a processor/controller 84 is provided within the housing interior 72. The processor/controller 84 is operable to control the input charging power generated by the photovoltaic panel 42 for storage in the battery cells 48A,48B. Optionally, the battery 46 may also include a battery management unit 86 (BMU) which operates independently, or in conjunction with the controller 84 to regulate battery cell 48A,48B charging and discharge. In a preferred construction the controller 84 includes wireless signal transmission and reception capability to transmit charging and discharge signals, and receive control signals for the processing controller 84 regulate the discharge of electricity stored in the battery cells 48A,48B to the LED module 44 in the operation of the street light 30. In a preferred embodiment the controller 84 is provided in wireless communication with a control system for the solar light installation as described in U.S. Pat. No. 10,414,495 , the entirety of which is incorporated herein by reference.

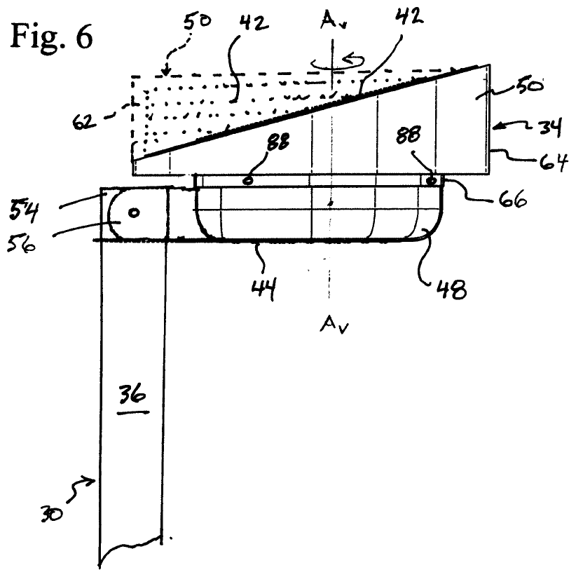

As shown in applicant's FIG. 6, the applicant has appreciated that with the present invention, that once the solar light assembly 34 is mounted to the light pole 36 in the desired operating position, the upper cover 50 may be rotated about a substantially central pivot axis A_{V}-A_{V}, and preferably a vertical axis from an initial position to an optimized position shown in phantom, to reposition the photovoltaic panel 42 for maximum solar efficiency. In particular, depending on both geographic factors, such as hemispheric latitude, as well as local environmental factors such as adjacent building and/or tree cover and the like, the upper cover 50 may be rotated about the vertical axis A_{V}-A_{V} to reposition the photovoltaic panel 42 to maximize efficiencies and generated power. Most preferably, the upper cover 50 is adapted for rotation relative to the bottom pan 48 and about the axis A_{V}-A_{V} between 90° and 359° of movement, and most preferably between 180° and at least 270° of movement, preferably at least about 360° of movement and most preferably at least about 540° of movement.

In a simplified construction, the upper cover 50 is repositionable by manual rotation, followed by the removing a series of lock screws 88 or other suitable mechanical fasteners. Once the upper cover 50 has been relocated to the optimized position, the lock screws 88 may be reinserted to fix the photovoltaic panel 42 in the reoriented position.

Although not essential, preferably the processor controller 84 is provided with a wireless transmitter/receiver 92. The transmitter/receiver 92 is adapted to remotely transmit information respecting battery cell hand charging/discharge performance, and further receive updated light pole programming control instructions to modify LED module operation.

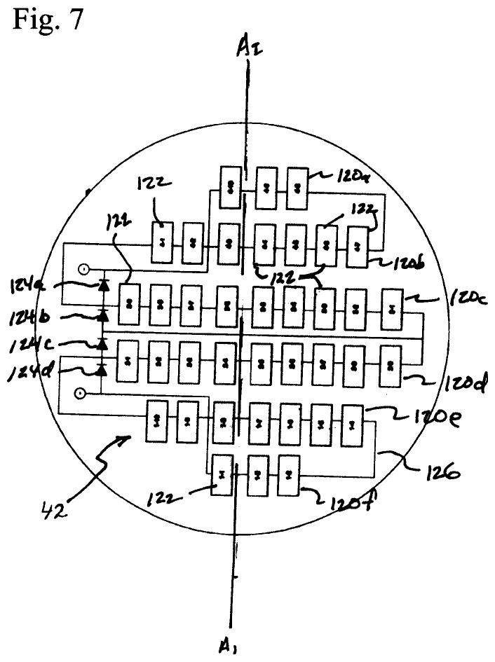

FIG. 7 shows best the layout of the individual PV cells 122 in each linear array 120a,120b,120c,120d,120e,120f, for an exemplary 31 W photovoltaic panel 42. In the embodiment shown, thirty-eight individual PV cells 122 are arranged in electrical series to provide a 31 W design target with an array voltage of less than 32 volts.

The photovoltaic panel 42 furthermore incorporates four bypass diodes 124a,124b,124c,124d. The bypass diodes 124a,124b,124c,124d are provided as part of the interconnecting electrical circuitry 126 to both protect individual shaded PV cells 122 from overheating and degrading, whilst minimizing the impact of cell shading on the total solar panel power generation.

In the case of debris, soiling, snow or ice accumulating along the lower edge portions of the solar panel 42, as for example as a result of gravity effects, the longitudinal orientation of each individual array 120a,120b,120c,120d,120e,120f is positioned normal to the axis of inclination A_{I}-A_{I} of the top surface 62. The applicant has appreciated that with the illustrated PV cell 122 arrangement, up to about the lowermost third of the photovoltaic panel 42, may be subject to the accumulation of debris and the like, with a resulting loss of power production, impacting only the photovoltaic cells 122 in the lowermost arrays 120e,120f which are electrically connected via bypass filter 124d.

It is to be appreciated that bypass diodes 124a,124b,124c,124d thus may advantageously be used to limit shading impacts as between adjacent arrays.

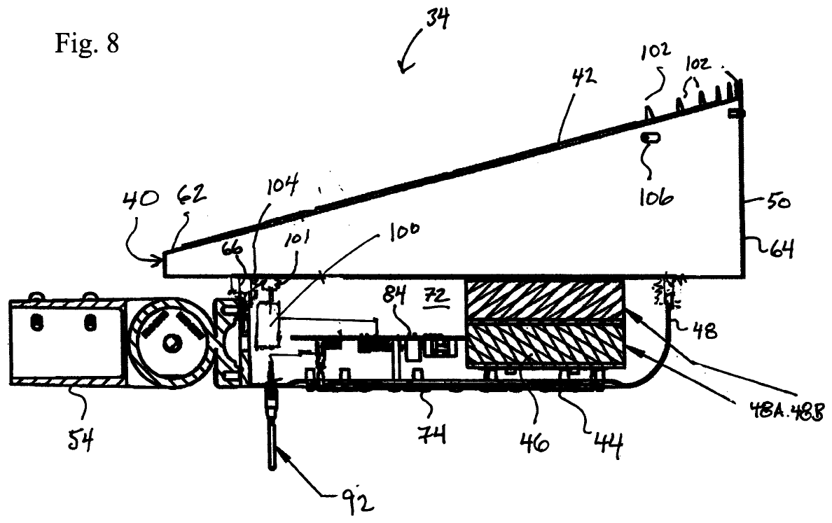

Reference may be had to FIG. 8 which illustrates a cross sectional view of the solar light assembly 34 in accordance with a further embodiment of the invention, wherein like reference numerals are used to identify like components.

In the solar light assembly 34 illustrated in FIG. 8, a drive motor 100 is provided within the housing interior. The drive motor 100 includes a motor output 101 which is provided an engagement with an annular track 104 of the upper cover 50.

The drive motor 100 is provided in an electric communication with the battery cells 48A,48B, and is selectively activatable by the processor controller 84 to journal the upper cover 50 in rotational movement about the bottom pan 48. In one possible mode, the processor controller 84 is operable to activate the drive motor 100 to effect reorientation of the photovoltaic panel 42 on a timed and/or calendar basis to optimize solar efficiency by time of day and/or seasonally.

In another non-limiting mode, the solar light assembly 34 may be provided with one or more optical light sensors 106 which are in electronic communications with the controller 84. Depending on signals received from the optical light sensors 106, the processor controller 84 may operate to selectively activate the drive motor 100 to effect repositioning of the photovoltaic panel 42 in response to sensed light intensities.

FIG. 8 further illustrates the upper cover 50 as including optionally one or more bird spikes 102 used to deter bird and animal roosting or nesting over the photovoltaic panel 42.

In a preferred installation, once the solar light assembly 34 is mounted on the pole 36 with the LED light panel 44 directed downwardly to the target area T_{A} in the operating position. The upper cover portion 50 is then selectively rotated relative to the base pan 48 about the axis A_{V}-A_{V} to effect the repositioning of the photovoltaic panel 42 relative to the pole 36. More preferably, with the solar light assembly 34 mounted in the operating position, the upper cover portion 50 is preferably rotated relative to the base through up to 359° of movement, preferably between about 100° and 359° of movement, and most preferably between about 200° and about 310° of movement.

The rotation of the upper cover portion 50 relative to the base pan 48 allows for the selective repositioning of the photovoltaic panel 42 in an orientation selected to optimize solar efficiency, depending on site-specific installation factors. Such factors may include without restricting proximity of surrounding building structures, tree coverage, overhead construction, site latitude, localized geographic features, and/or anticipated operational light pole loads.

Optionally, the bottom pan 48 may be provided with one or more additional sealable access parts leading into the housing interior 72. The access parts may for example be used to allow cable input for secondary AC and/or DC power sources, additional photovoltaic panel inputs, motion detector units, or Wi-Fi™ receivers and/or transmitters.

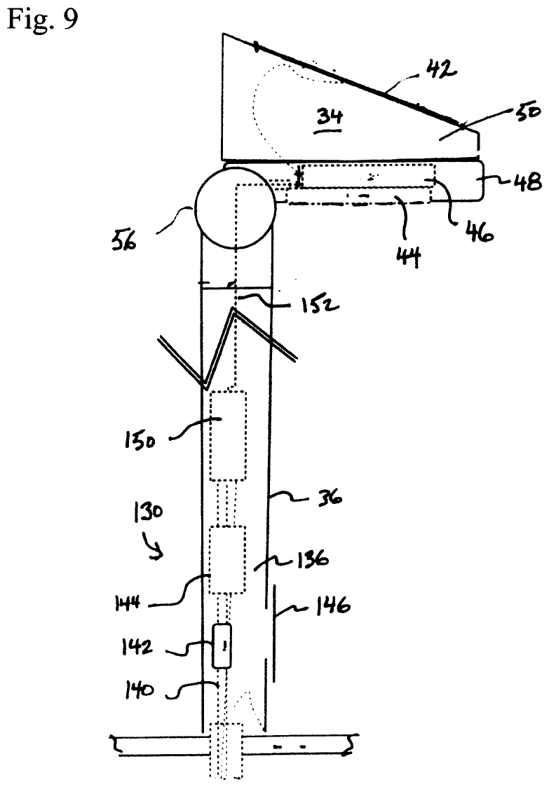

Reference may be had to FIG. 9 which illustrates a streetlight 130 which incorporates a solar light assembly 34 in accordance with a further embodiment of the invention, and wherein like reference numerals are used to identify like components. The streetlight 130 shown in FIG. 9 incorporates a solar light assembly 34 which is mounted on a light pole 36, and which is provided to retro fit a conventional incandescent streetlight. In particular, the solar light assembly 34 may be provided as a replacement for an end-of-light streetlight or alternately as a retrofit application for increased energy efficiency.

In retrofit applications, the conventional 120 volt or 240 volt power grid supply lines 140 are maintained. Although not essential, most preferably, an internal fuse 142 and AC plug connector 144 are provided within the pole interior 136 and which are accessible by way of a removable access panel 146. An AC/DC regulator 150 operates the power received from the grid 140 to low voltage, and preferably less than 30 vdc. The AC/DC regulator 150 is provided in electrical communication with the light assembly battery 46 by way of low voltage supply line 152 and the processor/controller 84.

In the embodiment shown in FIG. 9 conventional grid power at 120/208/220/240 V ac, 50/60 Hz is provided as an input power supply. The input power is fed to the AC/DC regulator 150 with power output therefrom at less than 30 vdc. The output power is thus supplied to the battery 46 as additional backup power during environmental and/or seasonal conditions result in the photovoltaic panel 42, generating insufficient power for optimized batter life and/or light module 44 operation. It is to be appreciated that with the construction shown in FIG. 9, the solar light assembly 34 may be provided with and/or used in conjunction with additional loads such as security cameras, radio and/or cellular communication transmitters or receivers and the like.

The construction shown in FIG. 9 may advantageously operate with the solar panel providing the primary power source to reduce overall energy consumption, whilst maximizing the life of the battery 46 by minimizing charge and discharge cycles.

In an alternative possible mode, the streetlight 130 may operate with power supplied by the primary grid source 140, and with the photovoltaic panel 42 and battery 46 providing backup power, as for example, in the event of a planned or unplanned grid outage.

Although the detailed description describes and illustrates various preferred embodiments, the invention is not limited to the preferred constructions which are described. Many modifications and variations will occur to persons skilled in the art.

1. A solar light assembly for mounting in an operating position to effect illumination of an underlying target area, the solar light assembly comprising an assembly housing, a photovoltaic panel, an electric lamp, an electric battery cell and a controller, the controller being operable to selectively electronically connect said battery cell with said photovoltaic panel and said electric lamp,
said housing comprising a lower pan portion and an upper cover portion,
the lower pan portion including a base adapted for fixed securement relative to an assembly support with the base in a generally horizontal orientation, the lamp being fixedly mounted to an underside of said base,
the upper cover portion including an upper surface, when the solar light is mounted in the operating position, the upper surface being inclined relative to the horizontal an angle selected at between about 10° and 33°, preferably between about 10° and 20°, and most preferably at about 15°, and with the upper portion being configured for selective rotational movement about a generally vertical axis relative to said lower pan portion,
the photovoltaic panel being mounted to said upper cover portion in a fixed orientation relative to said inclined upper surface for movement therewith.

2. The solar light assembly as claimed in claim 1 further including a drive assembly including a drive motor selectively activatable to journal the upper portion in rotational movement relative to the lower pan portion, and
the controller is operable to effect the selective activation and deactivation of the drive motor in response to at least one control factor selected from the group consisting of a time of day, a current localized weather event, and a time of year.

3. The solar light assembly as claimed in claim 1, wherein
the lower pan portion includes a radially extending sidewall extending upwardly from the base concentrically about the vertical axis,
the upper cover portion includes a radial lower portion adapted for juxtapositioning with at least part of said lower pan sidewall.

4. The solar light assembly as claimed in claim 1, wherein the upper cover portion and the lower pan portion define a substantially weather-tight interior cavity, the controller and the electric battery cell being housed within the interior cavity.

5. The solar light assembly as claimed in claim 1, wherein said upper surface comprises a substantially planar surface, and said photovoltaic panel comprises a substantially planar front surface, the photovoltaic panel being mounted to said upper cover portion with said planar front surface in a substantially coplanar orientation with said inclined upper surface, said photovoltaic panel is recessed at least partially in said inclined upper surface.

6. (canceled)

7. The solar light assembly as claimed in claim 1, wherein the bottom pan portion further includes a mounting assembly for securing the solar light assembly to said assembly support in a fixedly mounted orientation, and wherein the assembly support is selected from the group consisting of a light pole, a wall bracket and a support arm.

8. (canceled)

9. The solar light assembly as claimed in claim 1,
wherein said electric lamp comprises an LED array secured to or recessed at least partially into the underside of said base.

10. A solar light assembly for illuminating a target area, the solar light assembly being adapted for positioning spaced generally above said target area in a fixedly mounted orientation on a support, selected from a light pole, a wall bracket and a support arm, the assembly comprising a lamp housing, a photovoltaic panel, a luminaire and an electric power control assembly including at least one electric cell in electrical connection with the photovoltaic panel and the luminaire, and a controller,
the lamp housing including a lower pan portion and an upper cover portion, wherein in the fixedly mounted orientation,
the lower pan portion having a generally horizontally extending base and an upwardly extending sidewall extending radially about an edge portion of said base to an upper edge, and
the upper cover portion positionable over the lower pan portion to define an interior cavity therebetween, the upper cover portion having a generally planar top panel and a lower s portion beneath the cover portion, the top panel being oriented to an inclined angle relative to horizontal at an angle selected at between about 10° and 33°, preferably between about 10° and 20° and most preferably about 15°, the lower portion including a downwardly extending sidewall extending radially and concentric with at least part of said upwardly extending sidewall for juxtaposed placement therewith, wherein upper cover portion is configured for selective rotary positioning relative to said lower pan portion,
the photovoltaic panel being mounted to the top panel in a generally parallel planer relationship therewith,
the luminaire being mounted to said base in an orientation selected to emit light downwardly therefrom to illuminate said target area, and
the at least one electric cell and a controller housed within said interior cavity, the controller operable to control charging of said electric cell by said photovoltaic panel and the discharge of electricity therefrom in operation of the luminaire.

11. The solar light assembly as claimed in claim 10,
wherein the electric power control assembly further includes a wireless communications transmitter and receiver adapted to transmit and/or receive light assembly control programming.

12. The solar light assembly as claimed in claim 10,
wherein said luminaire is recessed at least partially into an underside of the said base.

13. The solar light assembly as claimed in claim 10,
wherein the photovoltaic panel is recessed into the top panel so as to be substantially coplanar therewith, and said luminaire is oriented to illuminate said target area with emitted light with a beam angle focus at substantially zero ±10° angle nadir.

14. The solar light assembly as claimed in claim 13,
wherein the lamp housing further includes a rotary stop to limit the rotation of the upper cover portion relative to said lower pan portion to between about 180° to 359° of movement, and preferably between about 210° and 300° of movement.

15. The solar light assembly as claimed in claim 14,
further including a removable securement member selectively positionable to secure said upper cover member against rotary movement relative to said lower pan member.

16. A solar light assembly for mounting to a support in a mounted orientation spaced above a target area to be illuminated, the solar light assembly including,
an assembly housing comprising a lower housing portion, an upper cover portion, an electric battery cell and a controller for controlling battery cell charging and/or discharge,
the lower housing portion adapted for fixed coupling to the support, the lower portion including,
a base, a base sidewall including a radially and upwardly extending portion, and an electric lamp secured to an underside of said base, whereby in the mounted position the electric lamp oriented to emit light energy downwardly toward said target area with a beam angle focus at the target area substantially at zero±angle nadir, the upper cover portion comprising:
a generally circular upper surface extending to an outermost radially extending edge and a substantially planar photovoltaic panel coupled to the upper surface,
a cover sidewall extending downwardly from said outermost radially extending edge towards said lower housing portion, a lower portion of the cover sidewall defining an inner annual sidewall adapted for juxtaposed placement with the radially and upwardly extending portion of the base sidewall,
whereby in the mounted position the upper surface and photovoltaic panel being inclined from horizontal at an angle of between about 10° and 33°, or at about 11°, 12°, 13°, 14°, 15°, 16° or 17°, and the upper cover portion being selectively rotatable relative to said lower housing portion about a substantially vertical axis between about 90° to at least 270°, preferably or at least 360°, or preferably-at least 540° of movement.

17. The solar light assembly as claimed in claim 16, wherein the upper surface merges with the cover sidewall to form a substantially rounded edge having a radial curvature selected to deter bird roosting.

18. The solar light assembly as claimed in claim 16, wherein the photovoltaic panel is substantially flush mounted with or on said upper surface.

19. The solar light assembly as claimed in claim 16, further including a secondary AC power source, and wherein the controller is configured to selectively provide AC-sourced electrical charging power to said battery cell.

20. The solar light assembly as claimed in claim 16, wherein said electric lamp comprises an LED array secured to or recessed at least partially into the underside of said base., the LED array selected to illuminate said target area in accordance with IES-RP-8-18; IES-RP-8-21; and/or IES-RP-33-14 standards.

21. The solar light assembly as claimed in claim 16, further including a wireless communications transmitter and receiver communicating with said controller and adapted to transmit and/or receive solar light assembly control programming.

22. The solar light assembly as claimed in claim 16, further including a removable securement member selectively positionable to secure said upper cover member against rotational movement relative to said base.
